(19) United States
(12) Patent Application Publication
(10) Pub. No.: US 2009/0328136 A1
(43) Pub. Date: Dec. 31, 2009

(54) TECHNIQUES FOR ROUTING PRIVACY SENSITIVE INFORMATION TO AN OUTPUT DEVICE

(76) Inventors: Chieh-Yih Wan, Hillsboro, OR (US); Manoj Sastry, Portland, OR (US); Mark Yarvis, Portland, OR (US); Rahul Shah, San Francisco, CA (US)

Correspondence Address: KACVINSKY LLC;C/O INTELLEVATE, P.O. BOX 52050, MINNEAPOLIS, MN, 55402, US

(21) Appl. No.: 12/164,656

(22) Filed: Jun. 30, 2008

(51) Int. Cl. G06F 17/00

(52) U.S. Cl. 726/1

(57) ABSTRACT

Various embodiments are directed to a privacy routing engine embodied on a device and a method for routing actuations to preserve a user's privacy. The privacy routing engine may receive actuations intended for a user, and may route the actuation to an output device according to a set of user output policies. The user output policies may specify output devices according to a user's context and need for privacy. A user context may include a location, an event, or a sensed condition. Other embodiments are described and claimed.

### DETAILED DESCRIPTION

In many applications of mobile devices a personal context for a user may be continuously collected from various sensors and reported to the user through a handheld device, such as a handheld computer, a personal digital assistant, a cellular telephone, a pager, a smartphone, a personal appliance (e.g., watch, ring, necklace, bracelet, etc.), and so forth. Personal data in these applications often carries important information that must be fed back to the user in real time, perhaps attracting attention through different forms of actuation. For example, a user that is exercising in the gym may want to be informed when his blood oxygenation level drops below a threshold value, so he can safely end his workout and cool down. There may be many forms of actuation available to the user. At the same time, the user may want to preserve his privacy and keep the actuation discreet, depending on a user's actions or locations.

To solve these and other problems, various embodiments may automatically determine how to deliver an actuation to a user discreetly according to a set of user policies, the type of actuation, and a user context. Embodiments may receive and store user policies for providing actuations according to various user-specified contexts and privacy needs. In this way, a user may remain informed through a mobile device of important events in a private and discreet manner. As a result, a user may improve the effective use of a mobile device in multiple environments while having an enhanced user experience.

FIG. 1 illustrates a block diagram of a privacy routing platform 100 according to one or more embodiments. In general, privacy routing platform 100 may comprise various physical and/or logical components for communicating information, which may be implemented as hardware components (e.g., computing devices, processors, logic devices), executable computer program instructions (e.g., firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation.

In various embodiments, the privacy routing platform 100 may be implemented by a computing platform such as a mobile platform, personal computer (PC) platform, and/or consumer electronics (CE) platform supporting various networking, communications, and/or multimedia capabilities. Such capabilities may be supported by various networks, such as a Wide Area Network (WAN), Local Area Network (LAN), Metropolitan Area Network (MAN), wireless WAN (WWAN), wireless LAN (WLAN), wireless MAN (WMAN), wireless personal area network (WPAN), Worldwide Interoperability for Microwave Access (WiMAX) network, broadband wireless access (BWA) network, the Internet, the World Wide Web, telephone network, radio network, television network, cable network, satellite network such as a direct broadcast satellite (DBS) network, Code Division Multiple Access (CDMA) network, third generation (3G) network such as Wide-band CDMA (WCDMA), fourth generation (4G) network, Time Division Multiple Access (TDMA) network, Extended-TDMA (E-TDMA) cellular radiotelephone network, Global System for Mobile Communications (GSM) network, GSM with General Packet Radio Service (GPRS) systems (GSM/GPRS) network, Synchronous Division Multiple Access (SDMA) network, Time Division Synchronous CDMA (TD-SCDMA) network, Orthogonal Frequency Division Multiplexing (OFDM) network, Orthogonal Frequency Division Multiple Access (OFDMA) network, North American Digital Cellular (NADC) cellular radiotelephone network, Narrowband Advanced Mobile Phone Service (NAMPS) network, Universal Mobile Telephone System (UMTS) network, and/or any other wired or wireless network in accordance with the described embodiments.

In some implementations, the privacy routing platform 100 may comprise a system within and/or coupled to a computing device such as PC, desktop PC, notebook PC, laptop computer, mobile internet device (MID), mobile computing device, smart phone, personal digital assistant (PDA), mobile telephone, combination mobile telephone/PDA, video device, television (TV) device, digital TV (DTV) device, high-definition TV (HDTV) device, media player device, gaming device, or other type of computing device in accordance with the described embodiments.

The computing device comprising the privacy routing platform 100 may form part of a wired communications system, a wireless communications system, or a combination of both. For example, the computing device may be arranged to communicate information over one or more types of wired communication links. Examples of a wired communication link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The computing device may be arranged to communicate information over one or more types of wireless communication links. Examples of a wireless communication link may include, without limitation, a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the mobile computing device may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the principles and techniques discussed herein may be implemented using various communication media and accompanying technology.

As shown, privacy routing platform 100 may comprise one or more actuation engines 102. Actuation engine 102 may detect and/or process data and generate useful feedback to be delivered to the user. For example, actuation engine 102 may monitor a user via sensors on the body. Actuation engine 102 may detect a potentially dangerous physical condition, such as sudden high blood pressure, or decreased blood oxygen levels, and may generate an actuation. Privacy routing platform 100 may include a variety of actuation engines 102 for different monitoring or alerting applications.

Privacy routing platform 100 may also comprise one or more context engines 103. Context engine 103 may generate context information providing context for a user. For example, context engine 103 may detect or be aware of a user's location (e.g. home, gym, work, etc.), activity (e.g. a board meeting, doctor's appointment, etc.), physical environment (e.g., indoor, outdoor, etc.), and other context information relevant to the user.

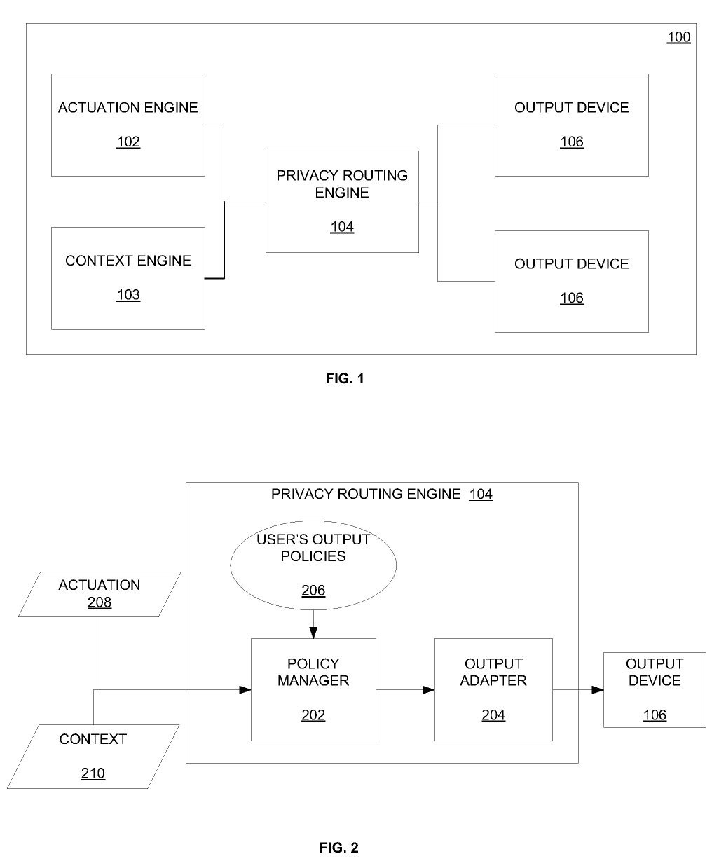

Privacy routing platform 100 may comprise a privacy routing engine 104 and one or more output devices 106. Privacy routine engine 104 may receive or intercept actuations from actuation engine 102. Privacy routing engine 104 may receive or intercept context information from context engine 103. Privacy routing engine 104 may select an output device according to user preferences as defined in a set of user output policies. The selected output device 106 may be used to display or otherwise notify the user of the actuation. Privacy routing engine 104 is discussed further below with respect to FIG. 2.

In an embodiment, privacy routing platform 100 may include at least one output device 106 that is capable of providing feedback in a form that is difficult to detect by anyone other than the device's owner or holder. An output device may operate in more than one actuation mode, to provide varying privacy levels. The actuation mode may be selected by the privacy routing engine 104.

Examples for the output devices 106 and possible actuation modes may include, for example, a local display, which may be a text-only display, or capable of a full-featured graphical user interface (GUI) display; a light emitting diode (LED) array, which may encode ranges of status values in color and/or pattern coding; a speaker, which may support buzzing or a ring tone coded to different ranges of status values, and/or a voice readout of actual content; a wrist vibrator, which may produce different vibration patterns, or vibrate at different position on a wrist band for different ranges of values; or a tactile actuator, which may generate tactile patterns for different ranges of values, or a tactile language (e.g., Braille) for the actual content, etc.

Output devices 106 may be embedded in privacy routing platform 100 or may be integrated as remote modules that connect to privacy routing platform 100 through a wired or wireless interface.

FIG. 2 illustrates a block diagram of an embodiment of privacy routing engine 104. Privacy routing engine 104 may include a policy manager 202, an output adapter 204, and one or more user output policies 206. Privacy routing engine 104 may receive, as inputs, actuations 208 from actuation engine 102 and/or context 210 from context engine 103. Actuations 208 and context 210 may be received from other sources as well.

Policy manager 202 may intercept actuations generated by actuation engine 102. Policy manager 202 may check the current context 210 and may search, parse, interpret or otherwise look up a user output policy in the user's output policies 206 to determine the output device(s) for the specific combination of actuation and context. Policy manager 202 may then pass the intercepted actuation and selected output device(s) to the output adapter 204.

Output adaptor 204 may receive the actuation and the selected output device(s) from policy manager 202. Output adaptor 204 may convert or adapt the actuation into a format that is appropriate for the selected output device(s).

For example, if the output device is “Speaker” in a voice mode, output adaptor 204 may interact with a voice readout engine (not shown) to convert the actuation text into a voice stream to be delivered to the speaker driver coupled to the platform. In another case, if the output device is “Wrist Vibration”, then output adaptor 204 may use the high level semantic information of the actuation 208 and context 210 to adapt the data for a format that can be presented by the wrist vibrator.

Output adaptor 204 may support application-specific plug-in modules for different output devices and may leverage other platform components to transform the actuation data to a format presentable by the output device. Such components may include, for example, a text-to-speech engine, and adaptive user interfaces that may deploy active proxies to adapt content and access protocols to the capabilities of output devices.

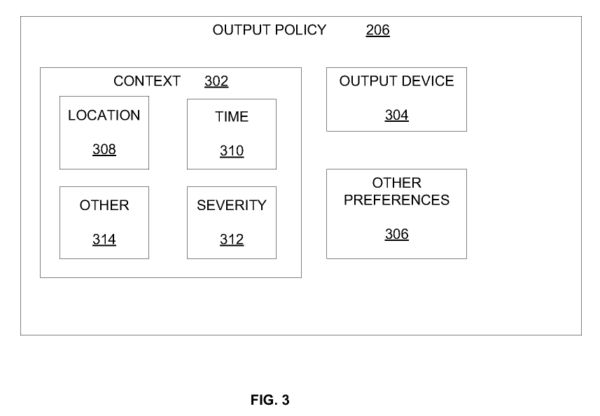

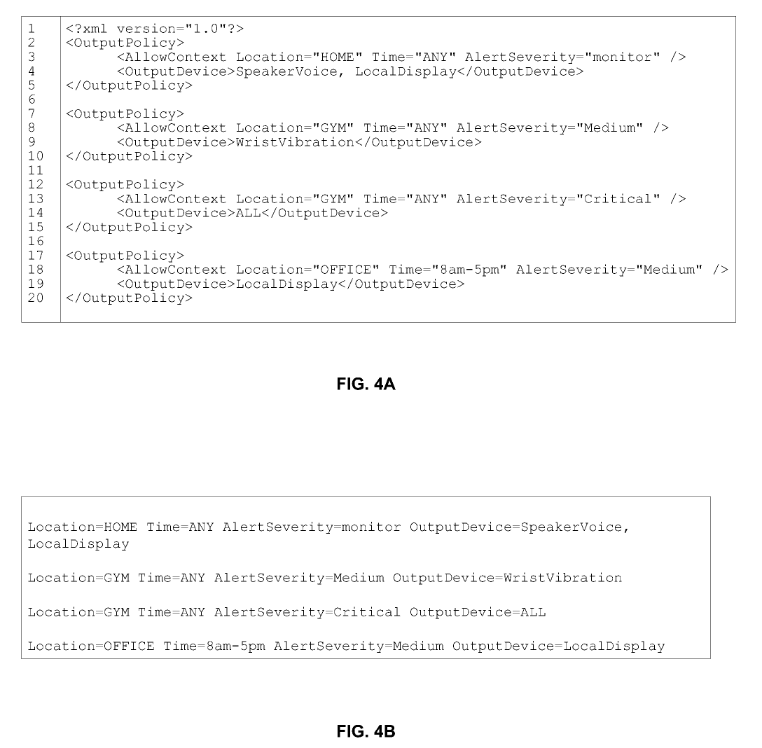

User output policies 206 may include one or more specifications for how a type of actuation should be routed according to a variety of possible parameters. User output policies are discussed in more detail with respect to FIG. 3.

An actuation 208 may include alerts about events or situations of interest to the user. Actuations 208 may be generated directly by the actuation engine 102, or may be received from other sources, e.g. an incoming phone call from a cell phone or voice-over IP (VOIP) call, etc.

Context 210 may include data about the user's current situation. Context 210 may include personal context data, such as health data, e.g., heart rate, oxygenation levels, etc. Context 210 may include physical context data, such as data about a user's environment, e.g. location, time, calendar event, etc. Context 210 may include other data pertinent to a user's privacy needs regarding receiving information from the platform device.

FIG. 3 illustrates an example of a user output policy 206. A policy 206 may include a context 302, a specified output device 304, and other preferences 306. A user policy context 302 may include specifications for a location 308, a time 310, a severity 312, and/or other specifications 314. The policy may be, for example, a text file, a spreadsheet, a database, an extensible markup language (XML) file, and so forth. An embodiment may provide a graphical interface for configuring user policies.

A policy may allow the user to specify, for example, a location, a time of day, an activity, a severity, an output device, or an output device mode. A specific policy may include multiple selections for a setting. For example, a policy may specify that in the location “home,” actuations should be sent to both a display and a speaker.

FIG. 4A illustrates an exemplary set of user output policies written in XML. The example lists four different policies, beginning at lines 2, 7, 12, and 17, respectively. The example assumes that at least three output devices are available to the privacy routing platform: a local display, a speaker and a wrist vibrator. The example policies consider three kinds of context in selecting an output device, namely location, local calendar time, and the severity of the actuation context. The actuation severity could be one of the following:
Critical—a life-threatening alert.
High/Medium/Low—an alert with specified level.
Monitor—the actuation context is not an alert, but regular monitoring data.

In FIG. 4A, each “OutputPolicy” entry may define a specific condition in which the actuation context should be routed to one or a set of output devices. For example, the first policy, beginning on line 2, specifies that if the user is at home, all regular monitoring data should be routed to both the platform speaker via voice readout, as well as the local display. The second policy, beginning on line 7, specifies that if the user is in the gym, then any actuation with medium severity should be routed to the wrist vibrator. The third policy, beginning on line 12, specifies that if the user is in the gym and an actuation is critical or life threatening, then it should be routed to all available output devices on the platform. The fourth policy, beginning on line 17, specifies that if the user is at the office, between the times of 8 a.m. and 5 p.m., then any actuation with medium severity should be routed to the local display.

FIG. 4B illustrates the same policies as shown in FIG. 4A, but in a text-only format. Other formats for policies are also possible. The embodiments are not limited in this respect.

The following describes various use scenarios for various embodiments. In one example, the user is riding an exercise bike at the gym with his workout buddy. The privacy routing platform 100 may be embodied on a mobile Internet device (MID), which may monitor the user's health status through multiple wireless sensors attached to his body. Halfway through the workout routine, the user's oxygenation level drops below 80% while the user's heart rate is high. Coaching software on the MID may generate an actuation. Because the MID is aware that the user is currently at a gym, privacy routing engine 104 may route the actuation to a vibration actuator on the user's wrist, instead of the platform's speaker. The user may feel the vibration, realize the problem, and may adjust his exercise level without the embarrassment of alerting others nearby. If the device detects a more serious situation, perhaps noting signs of a heart attack, an audible actuation may be more appropriate, thereby allowing others to render aid. If the user is at home, the user may desire an audible prompt for all actuations.

In another example, a user is reading news through his MID in the subway. The device may be aware that the user's context is a crowded public space. The device may therefore cause an incoming voice over IP (VoIP) call (e.g., Skype) to his MID to generate a popup message on the MID display instead of generating a ring tone.

In another example, the user may be a diabetic patient, and may use a MID to monitor her physiological status continuously. While in her office at work, the various physiological data shows up on her MID local display. When she is in a meeting, the privacy routing engine 104 may automatically reroute the data to an LED array on the MID, providing more discreet feedback. In some cases, only a subset of the data may be shown on the LED arrays due to the display capability of the LED arrays.

In another example, a user is displaying presentation slides via a laptop computer. The privacy routing platform 100 may be embodied on the laptop computer. During the presentation, the user may receive a live message on the laptop. Rather than displaying the message on both the laptop display and the presentation screen, the message may be discreetly routed to his wrist watch or cell phone.

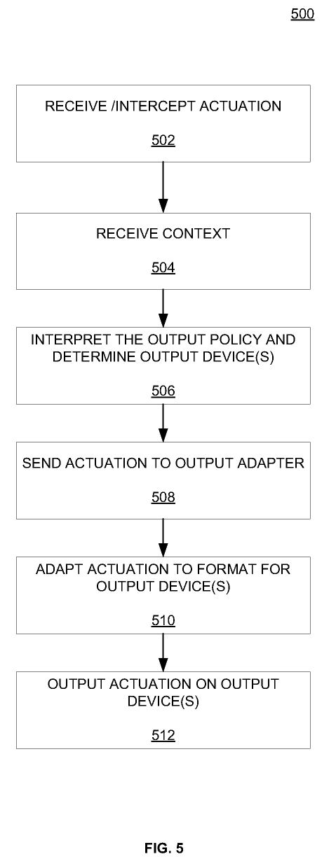

FIG. 5 illustrates a logic flow 500 for privacy routing. Starting in block 502, the privacy routing platform 100 may receive and/or intercept an actuation. The actuation may be received from actuation engine 102, or from another source in communication with privacy routing engine 104.

In block 504, privacy routing engine 104 may receive context data, for example, from context engine 103, or from another source in communication with privacy routing engine 104.

In block 506, privacy routing engine 104 may interpret the output policy that corresponds with the actuation and context, and may select the correct output device, and output mode, if specified.

In block 508, the actuation, context, and/or output device selection may be passed to the output adapter, if necessary. In block 510, the output adapter may format the actuation to a format and/or mode appropriate for the selected output device and output mode, if necessary.

In block 512, the actuation may be output on the selected output device. In an embodiment, blocks 508 and 510 may be skipped and actuation may be output directly to the selected output device.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated.

In various embodiments, the logic flow may comprise, or be implemented as, executable computer program instructions. The executable computer program instructions may be implemented by firmware, software, a module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computing device to perform a certain function. The executable computer program instructions may be implemented using any suitable programming language in accordance with the described embodiments. The executable computer program instructions may be provided for download from a server to a computing device such as those described above.

In various embodiments, logic flow may comprise, or be implemented as, executable computer program instructions stored in an article of manufacture and/or computer-readable storage medium implemented by various systems and/or devices in accordance with the described embodiments. The article and/or computer-readable storage medium may store executable computer program instructions that, when executed by a computing device, cause the computing device to perform methods and/or operations in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable media in accordance with the described embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within computing system registers and/or memories into other data similarly represented as physical quantities within the computing system memories, registers or other such information storage, transmission or display devices.

It is also worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method comprising:
receiving an actuation and a context for a user;
selecting an output device based on the context and a user output policy;
forwarding the actuation to the selected output device; and
outputting the actuation at the selected output device.

2. The method of claim 1, comprising adapting the actuation to a format for the selected output device.

3. The method of claim 1, comprising receiving the context comprising at least one of a location, a time or an actuation severity.

4. The method of claim 1, comprising:
receiving a user output policy comprising a context and an output device; and
storing the user output policy.

5. The method of claim 1, comprising selecting an actuation mode for the selected output device.

6. The method of claim 1, comprising selecting the output device from a plurality of output devices.

7. The method of claim 1, comprising receiving information from a sensor to generate the actuation.

8. An apparatus comprising:
a storage medium storing at least one user output policy;
a privacy routing engine operative to receive an actuation and a context and to select an output device according to the context and the at least one user output policy; and
an output adapter operative to format the actuation and forward the formatted actuation to the selected output device.

9. The apparatus of claim 8, the user output policy comprising at least one of a location, a time, an actuation severity, or at least one output device selection.

10. The apparatus of claim 8, the context comprising at least one of a location, an event, a time, or a sensed condition.

11. The apparatus of claim 8, comprising an actuation engine operative to generate the actuation.

12. The apparatus of claim 8, comprising a context engine operative to generate the context.

13. The apparatus of claim 8, comprising a plurality of output devices in communication with the output adapter.

14. The apparatus of claim 8, the output device comprising a display, a speaker, a light-emitting diode array, a vibrating device, or a tactile actuator.

15. An article comprising a storage medium containing instructions that if executed enable a system to:
receive an actuation and a context for a user;
select an output device based on the context and a user output policy; and
forward the actuation to the selected output device.

16. The article of claim 15, comprising instructions that if executed enable a system to generate the actuation from information received from a sensor.

17. The article of claim 15, comprising instructions that if executed enable a system to adapt the actuation to a format for the selected output device.

18. The article of claim 15, comprising receiving the context comprising a location, a time or an actuation severity.

19. The article of claim 15, comprising instructions that if executed enable a system to:
receive a user output policy comprising a context and an output device; and
store the user output policy.

20. The article of claim 15, comprising instructions that if executed enable a system to select an actuation mode for the selected output device.
